(19) United States
(12) Patent Application Publication
(10) Pub. No.: US 2025/0220601 A1
(43) Pub. Date: Jul. 3, 2025

(54) DERIVATION OF SSB INDEX ON TARGET CELLS

(71) Applicant: Apple Inc., Cupertino, CA (US)

(72) Inventors: Qiming Li, Beijing (CN); Dawei Zhang, Saratoga, CA (US); Yang Tang, San Jose, CA (US); Huaning Niu, San Jose, CA (US); Jie Cui, San Jose, CA (US); Manasa Raghavan, Sunnyvale, CA (US); Xiang Chen, Campbell, CA (US); Yushu Zhang, Beijing (CN)

(21) Appl. No.: 18/837,045

(22) PCT Filed: Feb. 12, 2022
(86) PCT No.: PCT/CN2022/076114

§ 371 Date: Aug. 8, 2024

(51) Int. Cl. H04W 56/00

(52) U.S. Cl. CPC H04W 56/0015

(57) ABSTRACT

Disclosed are methods, systems, and computer-readable medium to perform operations including: receiving, by a user equipment (UE) from a serving cell serving the UE, a message comprising: (i) synchronization signal block (SSB) information associated with a target SSB burst of a target cell, and (ii) a flag indicating that the UE is allowed to use timing of a reference cell to derive an index of the target SSB burst, wherein the target SSB burst comprises one or more SSBs; calculating a tolerance of a frame boundary alignment between the reference cell and the target cell; and determining, based on the tolerance, an index of the target SSB burst.

### CROSS-REFERENCE TO RELATED APPLICATIONS

The present application claims priority under 35 U.S.C. 371 to International Patent Application No. PCT/CN2022/076114, filed Feb. 12, 2022, the contents of which are hereby incorporated by reference.

### BACKGROUND

Wireless communication networks provide integrated communication platforms and telecommunication services to wireless user devices. Example telecommunication services include telephony, data (e.g., voice, audio, and/or video data), messaging, internet-access, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include code division multiple access (CDMA) networks, time division multiple access (TDMA) networks, frequency-division multiple access (FDMA) networks, orthogonal frequency-division multiple access (OFDMA) networks, Long Term Evolution (LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

For certain procedures in 5G NR, such as handover or adding Component Carriers (CCs), a user equipment (UE) is configured to measure signals from a serving cell of the UE and/or from a neighbor cell. 5G NR has introduced cell signal measurement by using a Synchronization Signal Block (SSB) that includes a Synchronization Signal (SS) and a Physical Broadcast Channel (PBCH). The SS includes a Primary Synchronization Signal (PSS) and a Secondary Synchronization Signal (SSS). The PBCH includes a PBCH demodulation reference signal (DMRS) and PBCH data. SSBs are used for Reference Signal Received Power (RSRP), Reference Signal Received Quality (RSRQ), and Signal to Interference & Noise Ratio (SINR) measurements.

### SUMMARY

This disclosure describes methods and systems for deriving an SSB index on a neighbor cell. In one example, the disclosed methods and systems can be used to derive the SSB index in scenarios where the inter-frequency target cell has a different SCS than the serving cell.

The present disclosure is directed towards methods, systems, apparatus, computer programs, or combinations thereof, for derivation of SSB index on target cells. In accordance with one aspect of the present disclosure, a method to be performed by a user equipment (UE) served by a serving cell involves: receiving, from the serving cell, a message including: (i) synchronization signal block (SSB) information associated with a target SSB burst of a target cell, and (ii) a flag indicating that the UE is allowed to use timing of a reference cell to derive an index of the target SSB burst, where the target SSB burst includes one or more SSBs; calculating a tolerance (Δt) of a frame boundary alignment between the reference cell and the target cell; and determining, based on the tolerance, an index of the target SSB burst.

Other versions include corresponding systems, apparatus, and computer programs to perform the actions of methods defined by instructions encoded on computer readable storage devices. These and other versions may optionally include one or more of the following features.

In some implementations, where the SSB information includes: a frequency of the target SSB burst and a subcarrier spacing of the target SSB burst.

In some implementations, the method further including: measuring, based on at least one of the tolerance (Δt) or the SSB information, at least a portion of the target SSB burst during a measurement window.

In some implementations, where measuring, based on at least one of the tolerance (Δt) or the SSB information, at least a portion of the target SSB burst includes calculating a time length of the measurement window as: window_length=a length of four SSB symbols of the target cell+2*Δt.

In some implementations, where determining index of the target SSB burst includes: determining, based on the tolerance, a candidate position of a first SSB in the target SSB burst; and determining, based on at least one of the candidate position of the first SSB or the measured portion of the target SSB index, the index of the target SSB burst.

In some implementations, where calculating the tolerance (Δt) includes calculating the tolerance as: Δt=min(2 SSB symbols of the reference cell, 1 PDSCH symbol of the reference cell).

In some implementations, where calculating the tolerance (Δt) includes calculating the tolerance as: Δt=2 SSB symbols of the target cell.

In some implementations, where calculating the tolerance (Δt) includes: receiving signaling indicative of an equation to use for calculating the tolerance; and calculating the tolerance based on the signaled equation.

In some implementations, where the signaled equation is one of: (i) Δt=min(2 SSB symbols of the reference cell, 1 PDSCH symbol of the reference cell), and (ii) Δt=2 SSB symbols of target cell.

In some implementations, where the tolerance includes a respective tolerance defined for each one of a plurality of predetermined SSB pattern cases.

In some implementations, where calculating the tolerance (Δt) includes: determining a first SSB pattern case associated with the target cell and a second SSB pattern case associated with the reference cell; determining that the first SSB pattern has a larger subcarrier spacing than the second SSB pattern; and calculating the tolerance based on the respective tolerance associated with the first SSB pattern.

In some implementations, where the plurality of predetermined SSB pattern cases include:

| | | FR1 | | | | FR2-1 | |
|---|---|---|---|---|---|---|---|
| | First SSB | <1.88 | 1.88 GHz < | 3 GHz~6 | | 24 GHz~52 | FR2-2 |
| Numerology | symbol | GHz | 3 GHz | GHz | Unlicensed | GHz | >60 GHz |
| Case A: 15 kHz | {2, 8} + 14*n | n = 0, 1 | | n = 0, 1, 2, 3 | n = 0, 1, 2, 3, | | |
| | | | | | 4 | | |
| Case B: 30 kHz | {4, 8, 16, 20} + | n = 0 | | n = 0, 1 | | | |
| | 28*n | | | | | | |
| Case C: 30 kHz | {2, 8} + 14*n | n = 0, 1 | | n = 0, 1, 2, 3 | n = {0~9} | | |
| FDD | | | | | | | |
| Case C: 30 kHz | | n = 0, 1 | n = 0, 1, 2, 3 | n = 0, 1, 2, 3 | | | |
| TDD | | | | | | | |
| Case D: 120 kHz | {4, 8, 16, 20} + | | | | | n = 0, 1, 2, 3, | |
| | 28*n | | | | | 5, 6, 7, 8, 10, | |
| | | | | | | 11, 12, 13, 15, | |
| | | | | | | 16, 17, 18 | |
| Case E: 240 kHz | {8, 12, 16, 20, | | | | | n = 0, 1, 2, 3, | |
| | 32, 36, 40, 44} + | | | | | 5, 6, 7, 8 | |
| | 56*n | | | | | | |
| Case F: 480 kHz | {2, 9} + 14*n | | | | | | n = {0~31} |
| Case G: 960 kHz | {2, 9} + 14*n | | | | | | n = {0~31} |

In some implementations, where the respective tolerance defined for case B, case D, or case E is calculated as: Δt=2 SSB symbols.

In some implementations, where the respective tolerance defined for case A or case C is calculated as: Δt=3 SSB symbols.

In some implementations, the respective tolerance defined for case F or case G is calculated as: Δt=3.5 SSB symbols.

In some implementations, where the respective tolerance defined for case B or D, and two consecutive SSB are transmitted is calculated as: Δt=6 SSB symbols.

In accordance with another aspect of the present disclosure, a method to be performed by a base station of a serving cell includes: generating, for a user equipment (UE) served by the serving cell, a message including: (i) synchronization signal block (SSB) information associated with a target SSB burst of a target cell, and (ii) a flag indicating that the UE is allowed to use timing of a reference cell to derive an index of the target SSB burst, where the target SSB burst includes one or more SSBs; and preparing the message for transmission to the UE.

Other versions include corresponding systems, apparatus, and computer programs to perform the actions of methods defined by instructions encoded on computer readable storage devices. These and other versions may optionally include one or more of the following features.

In some implementations, where the SSB information includes: a frequency of the target SSB burst and a subcarrier spacing of the target SSB burst.

In some implementations, the method further including: transmitting the message to the UE.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 illustrates an example of deriving an SSB index, in accordance with some embodiments.

FIG. 2 illustrates a wireless network, in accordance with some embodiments.

FIG. 3 illustrates another example of deriving an SSB index, in accordance with some embodiments.

FIG. 4A and FIG. 4B illustrate a flowchart of an example method, in accordance with some embodiments.

FIG. 5 illustrates a user equipment (UE), in accordance with some embodiments.

FIG. 6 illustrates an access node, in accordance with some embodiments.

### DETAILED DESCRIPTION

As stated above, 5G NR has introduced cell signal measurement by using Synchronization Signal Blocks (SSBs). In the time domain, an SSB spans four orthogonal frequency-division multiplexing (OFDM) symbols, and is periodically transmitted with a periodicity of 5 milliseconds (ms), 10 ms, 20 ms, 40 ms, 80 ms, or 160 ms. To enable beamforming and beam sweeping for SSBs, standards promulgated by the Third Generation Partnership Project (3GPP) have defined SS burst sets. An SS burst set includes a set of one or more SSBs, where each SSB can be transmitted on a different beam.

3GPP standards have defined different cases of time-domain patterns of SSB transmissions. In particular, the 3GPP standards have defined a set of symbols that have been specified as candidates for the start of an SSB transmission. For a half frame with SSB blocks, the first symbol indices for candidate SSBs are determined according to the subcarrier spacing (SCS) of SS/PBCH blocks, where index 0 corresponds to the first symbol of the first slot in a half-frame. The following cases are specified in 3GPP TS 38.213.

Case A—15 kHz SCS: the first symbols of the candidate SS/PBCH blocks have indexes of {2,8}+14·n.
For operation without shared spectrum channel access:
   For carrier frequencies smaller than or equal to 3 GHz, n=0,1.
   For carrier frequencies within FR1 larger than 3 GHz, n=0,1,2,3.
   For operation with shared spectrum channel access, as described in [TS 37.213], n=0, 1, 2, 3, 4.

Case B—30 kHz SCS: the first symbols of the candidate SS/PBCH blocks have indexes {4,8,16,20}+28·n. For carrier frequencies smaller than or equal to 3 GHz, n=0. For carrier frequencies within FR1 larger than 3 GHz, n=0,1.

Case C—30 kHz SCS: the first symbols of the candidate SS/PBCH blocks have indexes {2,8}+14·n.
For operation without shared spectrum channel access
   For paired spectrum operation
      For carrier frequencies smaller than or equal to 3 GHz, n=0,1. For carrier frequencies within FR1 larger than 3 GHz, n=0,1,2,3.
   For unpaired spectrum operation
      For carrier frequencies smaller than 1.88 GHz, n=0,1. For carrier frequencies within FR1 equal to or larger than 1.88 GHz, n=0,1,2,3.
   For operation with shared spectrum channel access, n=0, 1, 2, 3, 4, 5, 6, 7, 8, 9.

Case D—120 kHz SCS: the first symbols of the candidate SS/PBCH blocks have indexes {4,8,16,20}+28·n. For carrier frequencies within FR2, n=0, 1, 2, 3, 5, 6, 7, 8, 10, 11, 12, 13, 15, 16, 17, 18.

Case E—240 kHz SCS: the first symbols of the candidate SS/PBCH blocks have indexes {8,12,16,20,32,36,40,44}+56·n. For carrier frequencies within FR2-1, n=0, 1, 2, 3, 5, 6, 7, 8.

Case F—480 kHz SCS: the first symbols of the candidate SS/PBCH blocks have indexes {2,9}+14·n For carrier frequencies within FR2-2, n=0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31.

Case G—960 kHz SCS: the first symbols of the candidate SS/PBCH blocks have indexes {2,9}+14·n. For carrier frequencies within FR2-2, n=0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31. Cases A-G are summarized in Table 1.

TABLE 1
First symbol indexes for candidate SS/PBCH blocks

| | | FR1 | | | | FR2-1 | |
|---|---|---|---|---|---|---|---|
| | First SSB | <1.88 | 1.88 GHz < | 3 GHz~6 | | 24 GHz~52 | FR2-2 |
| Numerology | symbol | GHz | 3 GHz | GHz | Unlicensed | GHz | >60 GHz |
| Case A: 15 kHz | {2, 8} + 14*n | n = 0, 1 | | n = 0, 1, 2, 3 | n = 0, 1, 2, 3, | | |
| | | | | | 4 | | |
| Case B: 30 kHz | {4, 8, 16, 20} + | n = 0 | | n = 0, 1 | | | |
| | 28*n | | | | | | |
| Case C: 30 kHz | {2, 8} + 14*n | n = 0, 1 | | n = 0, 1, 2, 3 | n = {0~9} | | |
| FDD | | | | | | | |
| Case C: 30 kHz | | n = 0, 1 | n = 0, 1, 2, 3 | n = 0, 1, 2, 3 | | | |
| TDD | | | | | | | |
| Case D: 120 kHz | {4, 8, 16, 20} + | | | | | n = 0, 1, 2, 3, | |
| | 28*n | | | | | 5, 6, 7, 8, 10, | |
| | | | | | | 11, 12, 13, 15, | |
| | | | | | | 16, 17, 18 | |
| Case E: 240 kHz | {8, 12, 16, 20, | | | | | n = 0, 1, 2, 3, | |
| | 32, 36, 40, 44} + | | | | | 5, 6, 7, 8 | |
| | 56*n | | | | | | |
| Case F: 480 kHz | {2, 9} + 14*n | | | | | | n = {0~31} |
| Case G: 960 kHz | {2, 9} + 14*n | | | | | | n = {0~31} |

3GPP has also introduced an SSB-based measurement timing configuration window called an SMTC window. The SMTC window is indicative of a measurement periodicity and timings of SSBs that a UE can use for measurements. The SMTC window periodicity can be set in the same range of SSB periodicity (e.g., 5, 10, 20, 40, 80 or 160 ms). Additionally, the window duration can be set to 1, 2, 3, 4, or 5 ms, according to the number of SSBs transmitted on the cell being measured.

In 5G NR, measurement objects are defined for intra-frequency and inter-frequency measurements. The information indicative of the reference signals to be measured can be sent by the network using an IE MeasObjectNR. Such information can include a frequency/time location and subcarrier spacing of the reference signal. For example, the measurement configuration for an SSB is provided under measObjectToAddMod as part of a MeasObjectNR IE. The IE includes at least the following fields: ssbFrequency, ssbSubcarrierSpacing, smtc1, and smtc2. The field ssbFrequency provides the frequency of the SS associated with the measurement object. The field ssbSubcarrierSpacing provides the subcarrier spacing of the SSB. The fields smtc1 and smtc2 provide primary and secondary measurement timing configurations, respectively. The primary measurement timing configuration provides timing offset and duration for the SSB.

After receiving a MeasObjectNR IE, the UE can perform a measurement provided in the IE. In the case of an SSB set (also called an SSB burst), the UE can measure one or more SSBs included in the burst. When a UE receives an SSB in an SSB burst, it is important for the UE to identify the index of the SSB (i.e., which SSB within the burst has been received). This is particularly challenging when the UE is receiving an SSB from a target cell (i.e., a cell other than the serving cell or neighbor cell). To address this challenge, 3GPP introduced a field deriveSSB-IndexFromCell that enables UE to derive SSB indices of target cell(s) on the same frequency as the serving cell. This field is included in an SSB-ConfigMobility IE found within the IE MeasObjectNR of the neighbor cell. TS 38.331 defines deriveSSB-IndexFromCell as follows:

If this field is set to true, UE assumes SFN [System Frame Number] and frame boundary alignment across cells on the same frequency carrier as specified in TS 38.133 [14]. Hence, if the UE is configured with a serving cell for which (absoluteFrequencySSB, subcarrierSpacing) in ServingCellConfigCommon is equal to (ssbFrequency, ssbSubcarrierSpacing) in this MeasObjectNR, this field indicates whether the UE can utilize the timing of this serving cell to derive the index of SS block transmitted by neighbour cell. Otherwise, this field indicates whether the UE may use the timing of any detected cell on that target frequency to derive the SSB index of all neighbour cells on that frequency.

Furthermore, when deriveSSB-IndexFromCell is enabled, the UE assumes that frame boundary alignment (including half frame, subframe, and slot boundary alignment) across cells on the same frequency carrier is within a tolerance (Δt) not worse than min(2 SSB symbols, 1 PDSCH symbol). The UE also assumes that the SFN of all cells on the same frequency carrier are the same. Therefore, the UE can determine a candidate position of the first SSB within a burst (also referred to as SSB index #0 or SSB #0). If the UE measures an SSB within that candidate position, the UE can determine that the measured SSB is SSB #0. The UE can also derive candidate positions of the SSBs within the SSB burst (if any). For example, the UE can use Table 1 to derive candidate positions from the position of SSB #0 the respective positions of the remaining SSBs within the burst (if any).

The flag deriveSSB-IndexFromCell achieves many benefits. As an example, the flag reduce time for SSB index detection (T_{SSB_time_index}=0). As another example, the flag allows more symbols to be scheduled when scheduling restrictions apply. If the flag was not available, a UE would have to restrict the entire SMTC window for SSB detection as, without the flag, the UE does not know when the SSB will occur within the window.

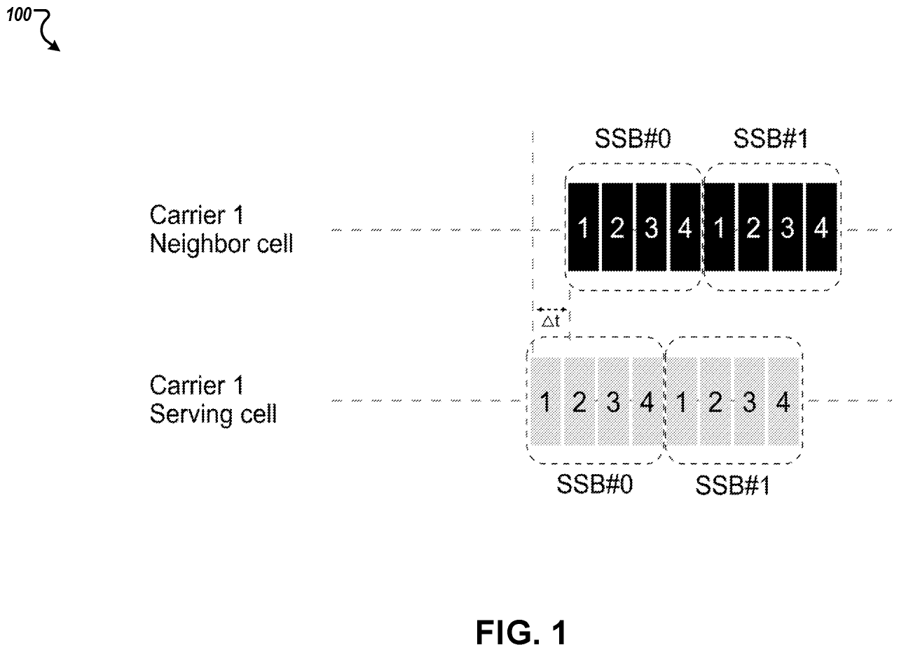

FIG. 1 illustrates an example 100 of deriving an SSB index, in accordance with some embodiments. In the example 100, a UE (not illustrated in FIG. 1) receives a flag deriveSSB-IndexFromCell. Accordingly, the UE assumes that frame boundary alignment (including half frame, subframe, and slot boundary alignment) across cells on the same frequency carrier is within a tolerance, Δt. The UE can therefore derive the SSB index of a target SSB burst broadcast by a neighbor cell. In particular, the UE knows that SSB index #0 will be received within a tolerance, Δt of the frame boundary of the SSB scheduled by the source cell. Accordingly, when the UE measures an SSB within the tolerance, the UE can determine that the measured SSB is SSB index #0.

In the example 100, the UE is measuring a target SSB burst on a neighbor cell 1 that, like the serving cell of the UE, is operating on carrier 1. Accordingly, the UE assumes that frame boundary alignment across the serving and neighbor cells is within a tolerance, Δt. Thus, the UE knows the UE knows the candidate position of the SSB #0 (i.e., the first SSB in the target SSB burst). When the UE detects an SSB within the tolerance, the UE knows that the detected SSB is SSB #0.

However, for the inter-frequency case, the meaning of the deriveSSB-IndexFromCell flag is different. The serving cell's timing cannot be used for an inter-frequency target cell. Rather, a UE has to read SSB index for at least one of the neighbor cells first, then derive the SSB index for other neighbor cells on the same inter-frequency carrier. It has been proposed that the IE be enhanced for inter-frequency cells with same SCS. In particular, RAN4 agreed to introduce a new network signaling [deriveSSB-IndexFromCell-inter] that informs a UE that the SSB indexes of target cell(s) on a frequency different than serving cell frequency can be derived from a serving cell. Further, the IE informs the UE which serving cell to utilize for target SSB indexes derivation. RAN4 has also agreed that the IE can only be configured if the SCS of SSB is the same between target cell and the serving cell used for SSB indexes derivation. However, this IE is not applicable for inter-frequency target cells that have a different SCS than the serving cell.

This disclosure describes methods and systems for deriving an SSB index on an inter-frequency neighbor cell. In one example, the disclosed methods and systems can be used to derive the SSB index in scenarios where the inter-frequency target cell has a different SCS than the serving cell.

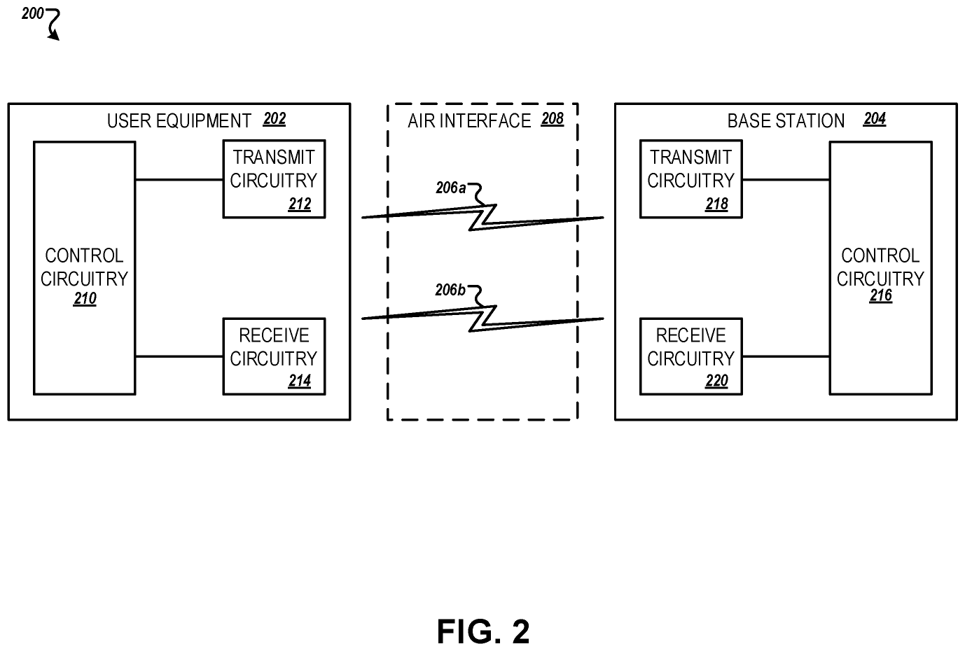

FIG. 2 illustrates a wireless network 200, in accordance with some embodiments. The wireless network 200 includes a UE 202 and a base station 204 connected via one or more channels 206A, 206B across an air interface 208. The UE 202 and base station 204 communicate using a system that supports controls for managing the access of the UE 202 to a network via the base station 204.

For purposes of convenience and without limitation, the wireless network 200 is described in the context of Long Term Evolution (LTE) and Fifth Generation (5G) New Radio (NR) communication standards as defined by the Third Generation Partnership Project (3GPP) technical specifications. More specifically, the wireless network 200 is described in the context of a Non-Standalone (NSA) networks that incorporate both LTE and NR, for example, E-UTRA (Evolved Universal Terrestrial Radio Access)-NR Dual Connectivity (EN-DC) networks, and NE-DC networks. However, the wireless network 200 may also be a Standalone (SA) network that incorporates only NR. Furthermore, other types of communication standards are possible, including future 3GPP systems (e.g., Sixth Generation (6G)) systems, IEEE 802.16 protocols (e.g., WMAN, WiMAX, etc.), or the like. While aspects may be described herein using terminology commonly associated with 5G NR, aspects of the present disclosure can be applied to other systems, such as 3G, 4G, and/or systems subsequent to 5G (e.g., 6G).

In the wireless network 200, the UE 202 and any other UE in the system may be, for example, laptop computers, smartphones, tablet computers, printers, machine-type devices such as smart meters or specialized devices for healthcare monitoring, remote security surveillance systems, intelligent transportation systems, or any other wireless devices with or without a user interface. In network 200, the base station 204 provides the UE 202 network connectivity to a broader network (not shown). This UE 202 connectivity is provided via the air interface 208 in a base station service area provided by the base station 204. In some embodiments, such a broader network may be a wide area network operated by a cellular network provider, or may be the Internet. Each base station service area associated with the base station 204 is supported by antennas integrated with the base station 204. The service areas are divided into a number of sectors associated with certain antennas. Such sectors may be physically associated with fixed antennas or may be assigned to a physical area with tunable antennas or antenna settings adjustable in a beamforming process used to direct a signal to a particular sector.

The UE 202 includes control circuitry 210 coupled with transmit circuitry 212 and receive circuitry 214. The transmit circuitry 212 and receive circuitry 214 may each be coupled with one or more antennas. The control circuitry 210 may be adapted to perform operations associated with selection of codecs for communication and to adaption of codecs for wireless communications as part of system congestion control. The control circuitry 210 may include various combinations of application-specific circuitry and baseband circuitry. The transmit circuitry 212 and receive circuitry 214 may be adapted to transmit and receive data, respectively, and may include radio frequency (RF) circuitry or front-end module (FEM) circuitry, including communications using codecs as described herein.

In various embodiments, aspects of the transmit circuitry 212, receive circuitry 214, and control circuitry 210 may be integrated in various ways to implement the circuitry described herein. The control circuitry 210 may be adapted or configured to perform various operations such as those described elsewhere in this disclosure related to a UE. The transmit circuitry 212 may transmit a plurality of multiplexed uplink physical channels. The plurality of uplink physical channels may be multiplexed according to time division multiplexing (TDM) or frequency division multiplexing (FDM) along with carrier aggregation. The transmit circuitry 212 may be configured to receive block data from the control circuitry 210 for transmission across the air interface 208. Similarly, the receive circuitry 214 may receive a plurality of multiplexed downlink physical channels from the air interface 208 and relay the physical channels to the control circuitry 210. The plurality of downlink physical channels may be multiplexed according to TDM or FDM along with carrier aggregation. The transmit circuitry 212 and the receive circuitry 214 may transmit and receive both control data and content data (e.g., messages, images, video, etc.) structured within data blocks that are carried by the physical channels.

FIG. 2 also illustrates the base station 204. In embodiments, the base station 204 may be an NG radio access network (RAN) or a 5G RAN, an E-UTRAN, a non-terrestrial cell, or a legacy RAN, such as a UTRAN or GERAN. As used herein, the term “NG RAN” or the like may refer to the base station 204 that operates in an NR or 5G wireless network 200, and the term “E-UTRAN” or the like may refer to a base station 204 that operates in an LTE or 4G wireless network 200. The UE 202 utilizes connections (or channels) 206A, 206B, each of which comprises a physical communications interface or layer.

The base station 204 circuitry may include control circuitry 216 coupled with transmit circuitry 218 and receive circuitry 220. The transmit circuitry 218 and receive circuitry 220 may each be coupled with one or more antennas that may be used to enable communications via the air interface 208.

The control circuitry 216 may be adapted to perform operations for analyzing and selecting codecs, managing congestion control and bandwidth limitation communications from a base station, determining whether a base station is codec aware, and communicating with a codec-aware base station to manage codec selection for various communication operations described herein. The transmit circuitry 218 and receive circuitry 220 may be adapted to transmit and receive data, respectively, to any UE connected to the base station 204 using data generated with various codecs described herein. The transmit circuitry 218 may transmit downlink physical channels comprised of a plurality of downlink subframes. The receive circuitry 220 may receive a plurality of uplink physical channels from various UEs, including the UE 202.

In this example, the one or more channels 206A, 206B are illustrated as an air interface to enable communicative coupling, and can be consistent with cellular communications protocols, such as a GSM protocol, a CDMA network protocol, a PTT protocol, a POC protocol, a UMTS protocol, a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any of the other communications protocols discussed herein. In embodiments, the UE 202 may directly exchange communication data via a ProSe interface. The ProSe interface may alternatively be referred to as a SL interface and may comprise one or more logical channels, including but not limited to a PSCCH, a PSSCH, a PSDCH, and a PSBCH.

In some embodiments, the wireless network 200 is configured to use a new field called deriveSSB-IndexFromCell-inter in a measurement object associated with neighbor cell (also called a target cell). In particular, the field can be used when the measurement object is for an SSB burst of a target cell, where the SSB burst or set includes one or more SSBs. The details of the SSB burst for measurement can be provided in ssb-ToMeasure. The deriveSSB-IndexFromCell-inter field indicates whether the UE 202 may use the timing of a reference cell to derive the SSB index of all neighbor cells on the frequency provided in the measurement object. In some examples, the reference cell is a serving cell of the UE 202 if the UE has only serving cell. However, if the UE 202 has multiple serving cells, deriveSSB-IndexFromCell-inter (or another field in ssb-ToMeasure) indicates which of the serving cells to use as a reference cell.

In some embodiments, the deriveSSB-IndexFromCell-inter field is a single bit that can be set to 0 or 1. In another example, the field is Boolean data type that can be set to false or true. If the field is set to 1 or true, the UE 202 assumes SFN and frame boundary alignment across cells on the neighbor frequency (e.g., as specified in TS 38.133).

In some embodiments, when the wireless network 200 enables deriveSSB-IndexFromCell-inter for the UE 202, the UE assumes that the frame boundary alignment (e.g., half frame, subframe, and/or slot boundary alignment) across cells on the same frequency carrier is not worse than a tolerance, Δt (i.e., within the tolerance). Additionally, the UE assumes that the SFNs of all cells on the same frequency carrier are the same.

In some embodiments, receiving a deriveSSB-IndexFromCell-inter set to true in a measurement object for a target cell enables the UE 202 to derive an SSB index for an SSB burst broadcast of that target cell. In one example, when the deriveSSB-IndexFromCell-inter is set to true, the UE 202 can determine a candidate location of SSB #0 in the target cell (even if the SSB is not transmitted). More specifically, with deriveSSB-IndexFromCell-inter set to true, the UE 202 can determine that a symbol boundary of SSB #0 of the target cell is within (−Δt˜Δt) of the frame boundary of the SSB #0 of the reference cell. Once the UE 202 determines the candidate location of the SSB #0, the UE can determine candidate locations for the remaining SSBs in the burst (if any). The UE 202 can do so even if the SSB #0 itself is not transmitted. In particular, the UE 202 can use the SSB pattern (e.g., as defined in Table 1) to determine candidate locations for the remaining SSBs in the burst (if any).

In some embodiments, the UE 202 may determine a window for measuring the target SSB burst. The target SSB is configured by the wireless network 100 via an RRC “SSB-ToMeasure.” SSB-ToMeasure indicates a set of SS blocks to be measured within the SMTC measurement duration (e.g., as described TS 38.215). When the field is absent, the UE measures on all SSB. In one example, the window length for measuring each SSB is equal to 4 SSB symbols of the target cell+2*Δt. The total measurement window is the combination of all measurement windows for each SSB to measured (e.g., as specified in SSB-ToMeasure).

In some embodiments, the UE 202 may be configured with one or more methodologies for calculating the tolerance, Δt. In one methodology, the tolerance is calculated using a predetermined equation. In one example, the tolerance is defined according to Equation [1]:

$$Δ t = min ( 2 SSB symbols of the reference cell , 1 PDSCH symbol of the reference cell ) \qquad [ 1 ]$$

In this example, the UE calculates Δt according to Equation [1] for all SSB pattern cases (e.g., described in Table 1). In another example, the tolerance is defined according to Equation [2]:

$$Δ t = 2 SSB symbols of target cell . \qquad [ 2 ]$$

In another methodology, the UE 202 receives network signaling that indicates to the UE the equation with which to calculate the tolerance. In this methodology, the UE 202 receives, from the wireless network 200, signaling indicative of the equation (e.g., Equation [1] or Equation [2]) to use for calculating the Δt associated with a particular measurement object. As such, the wireless network 200 can specify different equations for different measurement objects. For example, the wireless network 200 can specify that the UE 202 use Equation [1] for a measurement object associated with a first neighbor cell and use Equation [2] for a measurement object associated with a second neighbor cell.

In yet another methodology, the tolerance is determined based on the SSB pattern cases of the target cell and/or the reference cell. The SSB pattern cases are described in Table 1. In this methodology, a respective tolerance is defined for each SSB pattern case. However, there is an SSB pattern case associated with the reference cell and an SSB pattern case associated with the target cell. Therefore, in order to determine the tolerance to select, the UE 202 selects one of the SB pattern case associated with the reference cell and an SSB pattern case associated with the target cell. In one example, the UE 202 selects the SSB pattern case that has a larger SCS of the two. Once the UE 202 selects the SSB pattern case to use, the UE 202 selects the tolerance based on the selected pattern.

In some embodiments, SSB pattern cases that include consecutive candidate SSB locations are assigned the same respective tolerance. Such pattern cases includes cases B, D, and E from Table 1. In an example, the tolerance is calculated using Equation [3]:

$$Δ t = 2 SSB symbols . \qquad [ 3 ]$$

In these embodiments, SSB pattern cases A and C from Table 1 are assigned the same respective tolerance. In an example, the tolerance is calculated using Equation [4]:

$$Δ t = 3 SSB symbols . \qquad [ 4 ]$$

In these embodiments, SSB pattern cases F and G from Table 1 are assigned the same respective tolerance. In an example, the tolerance is calculated using Equation [5]:

$$Δ t = 3.5 SSB symbols . \qquad [ 5 ]$$

In Equations [3], [4], [5], the symbol duration of the SSB symbols is determined by the larger SCS of the reference cell and the target cell.

In some embodiments, for cases where the selected SSB pattern is case B or D from Table 1, and two consecutive SSB are transmitted, the tolerance is calculated using Equation [6]:

$$Δ t = 6 SSB symbols . \qquad [ 6 ]$$

In an example, a measurement object can include an indication that the target cell is transmitting two consecutive SSBs.

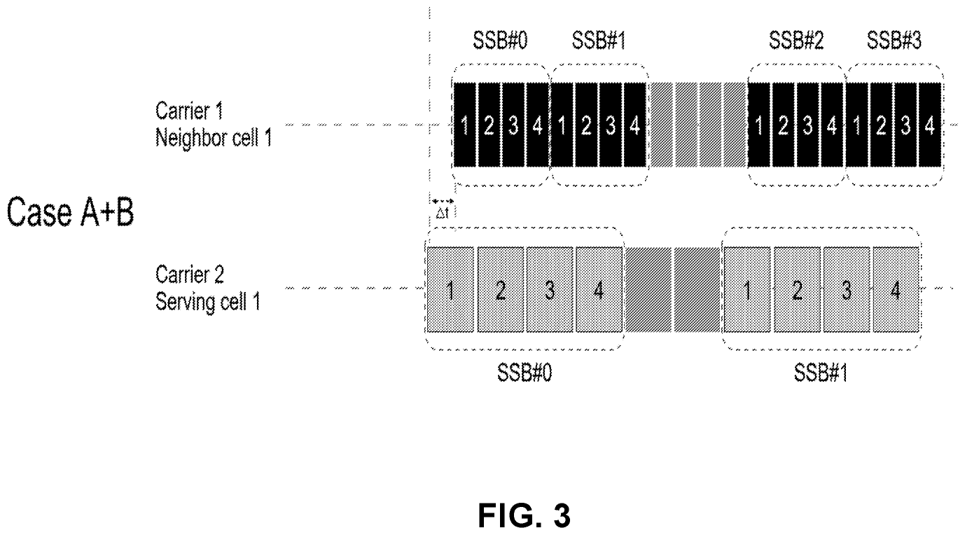

FIG. 3 illustrates an example 300 of deriving an SSB index, in accordance with some embodiments. In the example 300, a UE (not illustrated in FIG. 3) is served by serving cell 1 that is operating on Carrier 2. The UE receives a measurement object instructing the UE to measure an SSB burst of a neighbor cell 1 that is operating on Carrier 1. The measurement object also includes a field deriveSSB-IndexFromCell-inter set to true. Accordingly, the UE assumes that frame boundary alignment (including half frame, subframe, and slot boundary alignment) across all neighbor cells on Carrier 2 is within a tolerance, Δt. The UE can therefore derive the SSB index of a target SSB burst broadcast by neighbor cell 1. In particular, the UE knows that SSB #0 will be received within a tolerance, Δt of the frame boundary of the SSB scheduled by the serving cell 1. Accordingly, when the UE measures an SSB within the tolerance, the UE can determine that the measured SSB is SSB #0. In the example 300, the UE knows the UE knows the candidate position of SSB #0. When the UE detects an SSB within the tolerance, as shown in FIG. 3, the UE knows that the detected SSB is SSB #0. Furthermore, by knowing the location of SSB #0, the UE can derive the locations of the remaining SSBs (e.g., SSB #1, SSB #2, SSB #3).

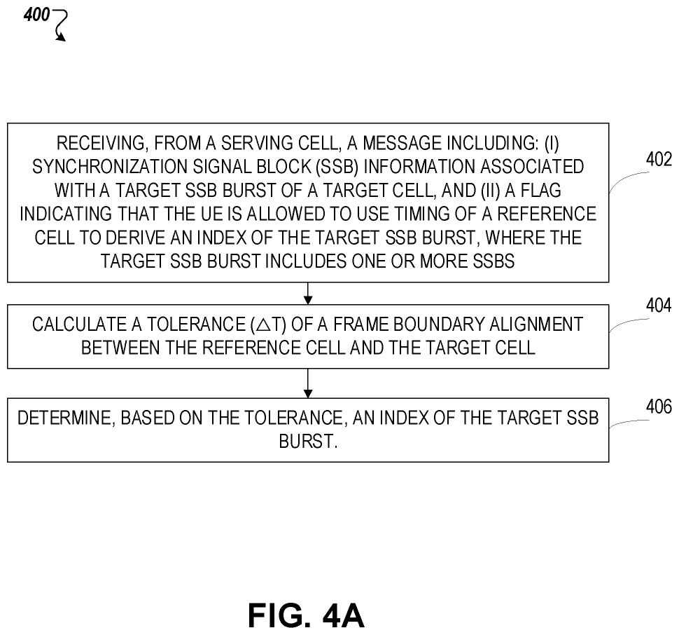

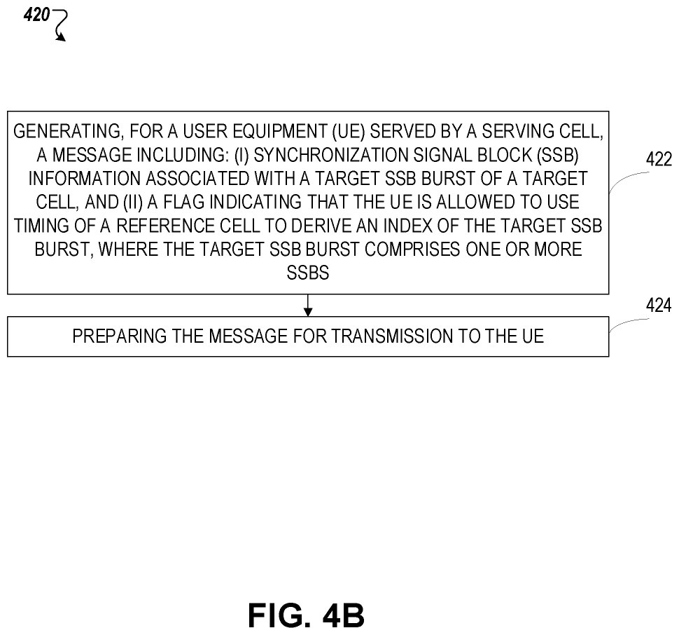

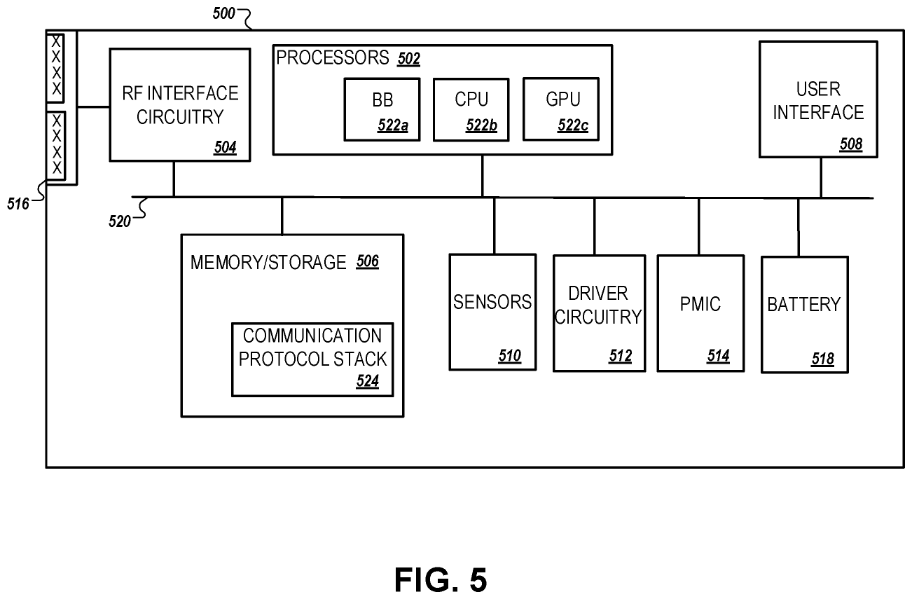

FIG. 4A illustrates a flowchart of an example method 400, according to some implementations. For clarity of presentation, the description that follows generally describes method 400 in the context of the other figures in this description. For example, method 400 can be performed by UE 500 of FIG. 5. It will be understood that method 400 can be performed, for example, by any suitable system, environment, software, hardware, or a combination of systems, environments, software, and hardware, as appropriate. In some implementations, various steps of method 400 can be run in parallel, in combination, in loops, or in any order.

At step 402, method 400 involves receiving, from a serving cell that serves the UE, a message including: (i) synchronization signal block (SSB) information associated with a target SSB burst of a target cell, and (ii) a flag indicating that the UE is allowed to use timing of a reference cell to derive an index of the target SSB burst, where the target SSB burst includes one or more SSBs.

At step 404, method 400 involves calculating a tolerance (Δt) of a frame boundary alignment between the reference cell and the target cell.

At 406, method 400 involves determining, based on the tolerance, an index of the target SSB burst.

In some implementations, where the SSB information includes: a frequency of the target SSB burst and a subcarrier spacing of the target SSB burst.

In some implementations, the method further including: measuring, based on at least one of the tolerance (Δt) or the SSB information, at least a portion of the target SSB burst during a measurement window.

In some implementations, where measuring, based on at least one of the tolerance (Δt) or the SSB information, at least a portion of the target SSB burst includes calculating a time length of the measurement window as: window_length=a length of four SSB symbols of the target cell+2* Δt.

In some implementations, where determining index of the target SSB burst includes: determining, based on the tolerance, a candidate position of a first SSB in the target SSB burst; and determining, based on at least one of the candidate position of the first SSB or the measured portion of the target SSB index, the index of the target SSB burst.

In some implementations, where calculating the tolerance (Δt) includes calculating the tolerance as: Δt=min(2 SSB symbols of the reference cell, 1 PDSCH symbol of the reference cell).

In some implementations, where calculating the tolerance (Δt) includes calculating the tolerance as: Δt=2 SSB symbols of the target cell.

In some implementations, where calculating the tolerance (Δt) includes: receiving signaling indicative of an equation to use for calculating the tolerance; and calculating the tolerance based on the signaled equation.

In some implementations, where the signaled equation is one of: (i) Δt=min(2 SSB symbols of the reference cell, 1 PDSCH symbol of the reference cell), and (ii) Δt=2 SSB symbols of target cell.

In some implementations, where the tolerance includes a respective tolerance defined for each one of a plurality of predetermined SSB pattern cases.

In some implementations, where calculating the tolerance (Δt) includes: determining a first SSB pattern case associated with the target cell and a second SSB pattern case associated with the reference cell; determining that the first SSB pattern has a larger subcarrier spacing than the second SSB pattern; and calculating the tolerance based on the respective tolerance associated with the first SSB pattern.

In some implementations, where the plurality of predetermined SSB pattern cases include:

| | | FR1 | | | | FR2-1 | |
|---|---|---|---|---|---|---|---|
| | First SSB | <1.88 | 1.88 GHz < | 3 GHz~6 | | 24 GHz~52 | FR2-2 |
| Numerology | symbol | GHz | 3 GHz | GHz | Unlicensed | GHz | >60 GHz |
| Case A: 15 kHz | {2, 8} + 14*n | n = 0, 1 | | n = 0, 1, 2, 3 | n = 0, 1, 2, 3, | | |
| | | | | | 4 | | |
| Case B: 30 kHz | {4, 8, 16, 20} + | n = 0 | | n = 0, 1 | | | |
| | 28*n | | | | | | |
| Case C: 30 kHz | {2, 8} + 14*n | n = 0, 1 | | n = 0, 1, 2, 3 | n = {0~9} | | |
| FDD | | | | | | | |
| Case C: 30 kHz | | n = 0, 1 | 0, 1, 2, 3 | n = 0, 1, 2, 3 | | | |
| TDD | | | | | | | |
| Case D: 120 kHz | {4, 8, 16, 20} + | | | | | n = 0, 1, 2, 3, | |
| | 28*n | | | | | 5, 6, 7, 8, 10, | |
| | | | | | | 11, 12, 13, 15, | |
| | | | | | | 16, 17, 18 | |
| Case E: 240 kHz | {8, 12, 16, 20, | | | | | n = 0, 1, 2, 3, | |
| | 32, 36, 40, 44} + | | | | | 5, 6, 7, 8 | |
| | 56*n | | | | | | |
| Case F: 480 kHz | {2, 9} + 14*n | | | | | | n = {0~31} |
| Case G: 960 kHz | {2, 9} + 14*n | | | | | | n = {0~31} |

In some implementations, where the respective tolerance defined for case B, case D, or case E is calculated as: Δt=2 SSB symbols.

In some implementations, where the respective tolerance defined for case A or case C is calculated as: Δt=3 SSB symbols.

In some implementations, the respective tolerance defined for case F or case G is calculated as: Δt=3.5 SSB symbols.

In some implementations, where the respective tolerance defined for case B or D, and two consecutive SSB are transmitted is calculated as: Δt=6 SSB symbols.

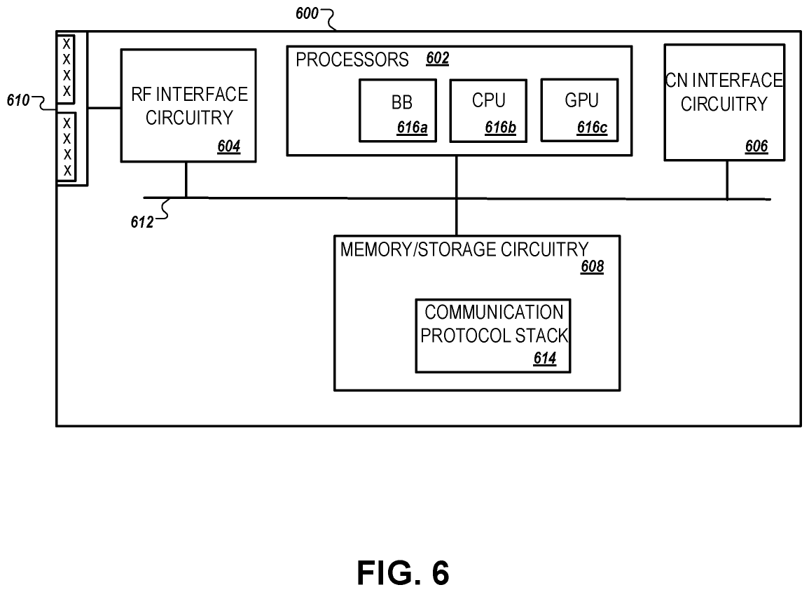

FIG. 4B illustrates a flowchart of an example method 420, according to some implementations. For clarity of presentation, the description that follows generally describes method 420 in the context of the other figures in this description. For example, method 420 can be performed by access node 600 of FIG. 6. It will be understood that method 420 can be performed, for example, by any suitable system, environment, software, hardware, or a combination of systems, environments, software, and hardware, as appropriate. In some implementations, various steps of method 420 can be run in parallel, in combination, in loops, or in any order.

At step 422, method 420 involves generating, for a user equipment (UE) served by a serving cell, a message including: (i) synchronization signal block (SSB) information associated with a target SSB burst of a target cell, and (ii) a flag indicating that the UE is allowed to use timing of a reference cell to derive an index of the target SSB burst, where the target SSB burst comprises one or more SSBs.

At step 424, method 420 involves preparing the message for transmission to the UE.

In some implementations, where the SSB information includes: a frequency of the target SSB burst and a subcarrier spacing of the target SSB burst.

In some implementations, the method further including: transmitting the message to the UE.

In some embodiments, a system, e.g., a base station, an apparatus comprising one or more baseband processors, and so forth, can be configured to perform particular operations or actions by virtue of having software, firmware, hardware, or a combination of them installed on the system that in operation causes or cause the system to perform the actions. The operations or actions performed either by the system can include methods 400, 420.

FIG. 5 illustrates a UE 500, in accordance with some embodiments. The UE 500 may be similar to and substantially interchangeable with UE 202 of FIG. 2.

The UE 500 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices (for example, a smart watch), relaxed-IoT devices.

The UE 500 may include processors 502, RF interface circuitry 504, memory/storage 506, user interface 508, sensors 510, driver circuitry 512, power management integrated circuit (PMIC) 514, antenna structure 516, and battery 518. The components of the UE 500 may be implemented as integrated circuits (ICs), portions thereof, discrete electronic devices, or other modules, logic, hardware, software, firmware, or a combination thereof. The block diagram of FIG. 5 is intended to show a high-level view of some of the components of the UE 500. However, some of the components shown may be omitted, additional components may be present, and different arrangement of the components shown may occur in other implementations.

The components of the UE 500 may be coupled with various other components over one or more interconnects 520, which may represent any type of interface, input/output, bus (local, system, or expansion), transmission line, trace, optical connection, etc. that allows various circuit components (on common or different chips or chipsets) to interact with one another.

The processors 502 may include processor circuitry such as, for example, baseband processor circuitry (BB) 522A, central processor unit circuitry (CPU) 522B, and graphics processor unit circuitry (GPU) 522C. The processors 502 may include any type of circuitry or processor circuitry that executes or otherwise operates computer-executable instructions, such as program code, software modules, or functional processes from memory/storage 506 to cause the UE 500 to perform operations as described herein.

In some embodiments, the baseband processor circuitry 522A may access a communication protocol stack 524 in the memory/storage 506 to communicate over a 3GPP compatible network. In general, the baseband processor circuitry 522A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer. In some embodiments, the PHY layer operations may additionally/alternatively be performed by the components of the RF interface circuitry 504. The baseband processor circuitry 522A may generate or process baseband signals or waveforms that carry information in 3GPP-compatible networks. In some embodiments, the waveforms for NR may be based cyclic prefix OFDM “CP-OFDM” in the uplink or downlink, and discrete Fourier transform spread OFDM “DFT-S-OFDM” in the uplink.

The memory/storage 506 may include one or more non-transitory, computer-readable media that includes instructions (for example, communication protocol stack 524) that may be executed by one or more of the processors 502 to cause the UE 500 to perform various operations described herein. The memory/storage 506 include any type of volatile or non-volatile memory that may be distributed throughout the UE 500. In some embodiments, some of the memory/storage 506 may be located on the processors 502 themselves (for example, L1 and L2 cache), while other memory/storage 506 is external to the processors 502 but accessible thereto via a memory interface. The memory/storage 506 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 504 may include transceiver circuitry and radio frequency front module (RFEM) that allows the UE 500 to communicate with other devices over a radio access network. The RF interface circuitry 504 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 516 and proceed to filter and amplify (with a low-noise amplifier) the signal. The signal may be provided to a receiver of the transceiver that downconverts the RF signal into a baseband signal that is provided to the baseband processor of the processors 502.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 516.

In various embodiments, the RF interface circuitry 504 may be configured to transmit/receive signals in a manner compatible with NR access technologies.

The antenna 516 may include antenna elements to convert electrical signals into radio waves to travel through the air and to convert received radio waves into electrical signals. The antenna elements may be arranged into one or more antenna panels. The antenna 516 may have antenna panels that are omnidirectional, directional, or a combination thereof to enable beamforming and multiple input, multiple output communications. The antenna 516 may include microstrip antennas, printed antennas fabricated on the surface of one or more printed circuit boards, patch antennas, phased array antennas, etc. The antenna 516 may have one or more panels designed for specific frequency bands including bands in FR1 or FR2.

The user interface 508 includes various input/output (I/O) devices designed to enable user interaction with the UE 500. The user interface 508 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 500.

The sensors 510 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 512 may include software and hardware elements that operate to control particular devices that are embedded in the UE 500, attached to the UE 500, or otherwise communicatively coupled with the UE 500. The driver circuitry 512 may include individual drivers allowing other components to interact with or control various input/output (I/O) devices that may be present within, or connected to, the UE 500. For example, driver circuitry 512 may include a display driver to control and allow access to a display device, a touchscreen driver to control and allow access to a touchscreen interface, sensor drivers to obtain sensor readings of sensor circuitry 528 and control and allow access to sensor circuitry 528, drivers to obtain actuator positions of electro-mechanic components or control and allow access to the electro-mechanic components, a camera driver to control and allow access to an embedded image capture device, audio drivers to control and allow access to one or more audio devices.

The PMIC 514 may manage power provided to various components of the UE 500. In particular, with respect to the processors 502, the PMIC 514 may control power-source selection, voltage scaling, battery charging, or DC-to-DC conversion.

In some embodiments, the PMIC 514 may control, or otherwise be part of, various power saving mechanisms of the UE 500 including DRX as discussed herein. A battery 518 may power the UE 500, although in some examples the UE 500 may be mounted deployed in a fixed location, and may have a power supply coupled to an electrical grid. The battery 518 may be a lithium ion battery, a metal-air battery, such as a zinc-air battery, an aluminum-air battery, a lithium-air battery, and the like. In some implementations, such as in vehicle-based applications, the battery 518 may be a typical lead-acid automotive battery.

In some embodiments, one or more elements of the UE 500 are configured to perform operations comprising receiving, from a serving cell that serves the UE, a message including: (i) synchronization signal block (SSB) information associated with a target SSB burst of a target cell, and (ii) a flag indicating that the UE is allowed to use timing of a reference cell to derive an index of the target SSB burst, where the target SSB burst includes one or more SSBs; calculating a tolerance of a frame boundary alignment between the reference cell and the target cell; and determining, based on the tolerance, an index of the target SSB burst.

FIG. 6 illustrates an access node 600 (e.g., a base station or gNB), in accordance with some embodiments. The access node 600 may be similar to and substantially interchangeable with base station 204. The access node 600 may include processors 602, RF interface circuitry 604, core network (CN) interface circuitry 606, memory/storage circuitry 608, and antenna structure 610.

The components of the access node 600 may be coupled with various other components over one or more interconnects 612. The processors 602, RF interface circuitry 604, memory/storage circuitry 608 (including communication protocol stack 614), antenna structure 610, and interconnects 612 may be similar to like-named elements shown and described with respect to FIG. 5. For example, the processors 602 may include processor circuitry such as, for example, baseband processor circuitry (BB) 616A, central processor unit circuitry (CPU) 616B, and graphics processor unit circuitry (GPU) 616C.

The CN interface circuitry 606 may provide connectivity to a core network, for example, a 5th Generation Core network (5GC) using a 5GC-compatible network interface protocol such as carrier Ethernet protocols, or some other suitable protocol. Network connectivity may be provided to/from the access node 600 via a fiber optic or wireless backhaul. The CN interface circuitry 606 may include one or more dedicated processors or FPGAs to communicate using one or more of the aforementioned protocols. In some implementations, the CN interface circuitry 606 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can comprise ground stations (e.g., terrestrial access points) or satellite stations providing coverage within a geographic area (e.g., a cell). As used herein, the term “NG RAN node” or the like may refer to an access node 600 that operates in an NR or 5G system (for example, a gNB), and the term “E-UTRAN node” or the like may refer to an access node 600 that operates in an LTE or 4G system (e.g., an eNB). According to various embodiments, the access node 600 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some embodiments, all or parts of the access node 600 may be implemented as one or more software entities running on server computers as part of a virtual network, which may be referred to as a CRAN and/or a virtual baseband unit pool (vBBUP). In these embodiments, the CRAN or vBBUP may implement a RAN function split, such as a PDCP split wherein RRC and PDCP layers are operated by the CRAN/vBBUP and other L2 protocol entities are operated by the access node 600; a MAC/PHY split wherein RRC, PDCP, RLC, and MAC layers are operated by the CRAN/vBBUP and the PHY layer is operated by the access node 600; or a “lower PHY” split wherein RRC, PDCP, RLC, MAC layers and upper portions of the PHY layer are operated by the CRAN/vBBUP and lower portions of the PHY layer are operated by the access node 600.

In V2X scenarios, the access node 600 may be or act as RSUs. The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

In some embodiments, one or more elements of the access node 600 may be configured to perform operations including generating, for a user equipment (UE) served by a serving cell, a message including: (i) synchronization signal block (SSB) information associated with a target SSB burst of a target cell, and (ii) a flag indicating that the UE is allowed to use timing of a reference cell to derive an index of the target SSB burst, where the target SSB burst comprises one or more SSBs; and preparing the message for transmission to the UE.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1-20. (canceled)

21. A user equipment (UE) configured to perform operations comprising:
receiving a parameter comprising a flag indicating that the UE is allowed to use timing of a reference cell to derive an index of a target synchronization signal block (SSB) burst of a target cell, wherein the target SSB burst comprises one or more SSBs; and
in response to receiving the parameter, calculating a tolerance (Δt) of a frame boundary alignment between the reference cell and the target cell.

22. The UE of claim 21, the operations further comprising:
determining, based on the tolerance (Δt), the index of the target SSB burst.

23. The UE of claim 21, wherein calculating the tolerance (Δt) comprises calculating the tolerance (Δt) as:
$$Δ t = min ( 2 SSB symbols , 1 PDSCH symbol ) .$$

24. The UE of claim 21, wherein calculating the tolerance (Δt) comprises calculating the tolerance based on 2 SSB symbols of the target cell.

25. The UE of claim 21, the operations further comprising:
in response to receiving the parameter, determining that System Frame Numbers (SFNs) are aligned across cells on a target carrier of the target cell.

26. The UE of claim 21, the operations further comprising:
receiving an information element (IE) comprising SSB information associated with the target SSB burst of the target cell.

27. The UE of claim 26, wherein the SSB information comprises at least one of a frequency of the target SSB burst and a subcarrier spacing of the target SSB burst.

28. The UE of claim 26, wherein the IE includes further includes the parameter.

29. The UE of claim 21, the operations further comprising:
measuring, based on the tolerance (Δt), at least a portion of the target SSB burst during a measurement window.

30. The UE of claim 29, wherein measuring, based on the tolerance (Δt), at least a portion of the target SSB burst comprises:
calculating a time length of the measurement window as: window_{length}=a length of four SSB symbols of the target cell+2*Δt.

31. A base station configured to perform operations comprising:
generating, for a user equipment (UE), a parameter comprising a flag indicating that the UE is allowed to use timing of a reference cell to derive an index of a target synchronization signal block (SSB) burst of a target cell, wherein the target SSB burst comprises one or more SSBs; and
preparing the parameter for transmission to the UE.

32. The base station of claim 31, the operations further comprising:
generating an information element (IE) comprising SSB information associated with the target SSB burst of the target cell.

33. The base station of claim 32, wherein the SSB information comprises at least one of a frequency of the target SSB burst or a subcarrier spacing of the target SSB burst.

34. The base station of claim 32, wherein the IE further includes the parameter.

35. The base station of claim 31, wherein the flag further indicates that System Frame Numbers (SFNs) are aligned across cells on a target carrier of the target cell.

36. One or more processors of a user equipment (UE), the one or more processors configured to perform operations comprising:
receiving a parameter comprising a flag indicating that the UE is allowed to use timing of a reference cell to derive a synchronization signal block (SSB) index of inter-frequency neighboring cells on a target carrier; and
in response to receiving the parameter, determining that a frame boundary alignment across the inter-frequency neighboring cells on the target carrier and the reference cell is within a tolerance not worse than a calculated tolerance.

37. The one or more processors of claim 36, further comprising:
determining, based on the calculated tolerance, an index of a target SSB burst on the target carrier.

38. The one or more processors of claim 36, wherein the calculated tolerance is calculated as:
$$Δ t = min ( 2 SSB symbols , 1 PDSCH symbol ) .$$

39. The one or more processors of claim 36, wherein the calculated tolerance is calculated based on 2 SSB symbols of the target carrier.

40. The one or more processors of claim 36, the operations further comprising:
in response to receiving the parameter, determining that System Frame Numbers (SFNs) of the inter-frequency neighboring cells on the target carrier are the same.
